(19) United States
(12) Patent Application Publication
(10) Pub. No.: US 2006/0119452 A1
(43) Pub. Date: Jun. 8, 2006

(54) Apparatuses for coupling radio frequency signal power

(76) Inventors: Kevin Kim, Palatine, IL (US); Mitchell R. Blozinski, Lake in the Hills, IL (US)

Correspondence Address: MOTOROLA, INC., 1303 EAST ALGONQUIN ROAD, IL01/3RD, SCHAUMBURG, IL, 60196, US

(21) Appl. No.: 11/007,003

(22) Filed: Dec. 8, 2004

(51) Int. Cl. H01P 5/18

(52) U.S. Cl. 333/117

(57) ABSTRACT

In the present technique of radio frequency power coupling, an electro magnetic waveguide (324) is provided to connect isolation ports (314, 322) of at least two of three couplers (302, 304, 306) in a coupler network (300).

### TECHNICAL FIELD

This invention relates generally to a technique for coupling radio frequency signal power.

### BACKGROUND

Quadrature hybrid couplers are commonly used on a circuit for dividing or combining radio frequency signal power. For example, FIG. 1 shows a prior art quadrature hybrid coupler, indicated generally at 100, according to its general layout 102 and symbol 104 formats. Specifically, the layout 102 of the quadrature hybrid coupler 100 shows a 3 dB directional coupler with a 90° phase difference at each of the parallel ports 106, 108, 110, 112. There are other 3 dB couplers, such as an edge coupled coupler, a broadside coupled coupler, a Lange coupler, or a rat-race or ring coupler (i.e., a 180° coupler) that can be used as quadrature hybrid couplers, as well. These types of couplers are often constructed in microstrip or stripline form 114. Because of the configuration of the quadrature hybrid coupler, it is also know as a branch-line hybrid coupler as shown in FIG. 1.

The branch-line hybrid coupler is typically either used as a power divider or combiner on the circuit board. In the case of the power divider with, for example, all ports matching to 50 Ω, the radio frequency (“RF”) power entering port P1 106 is equally divided between ports P3 110 and P4 112 with a 90° phase difference, wherein no power is coupled to port P2 108. In the case of the power combiner with all ports matched to 50 Ω, on the other hand, the RF power enters port P1 106 and port P2 108 at the same amplitude and frequency, but RF power entering port P1 is lagging compared to port P2 by 90° or vice versa depending on the output port. For this example, the RF power entering port P1 106 and port P2 108 is combined at port P3 110, which results in port P1 lagging port P2 by 90° and port P4 112 being isolated since no power is coupled to it. Moreover, because with all the ports 106, 108, 110, 112 matching, the parallel ports on each side, such as ports P1 and P2 and ports P3 and P4, are isolated from each other.

The basic operation of the branch-line hybrid coupler, as described, has a high degree of symmetry. For the power divider case, any port can be used as an input port. The output ports, however, are always on the opposite side of the junction from the input port. The remaining port on the same side as the input port is usually the isolated port. The isolated port is often terminated with a resistor to ground. The resistor value is the characteristic impedance of the isolated port, which is often referred to as an isolation resistor/load. One quadrature hybrid coupler can be used to divide RF power to two outputs or combine two RF powers at the same frequency. In order to divide the RF power to more than two outputs or combine more than two RF powers at the same frequency, however, a series, parallel, or corporate combining network is generally used, which is shown in FIG. 2.

Turning now to FIG. 2, a typical quadrature hybrid coupler network is shown and generally indicated at 200. As shown, the corporate network is a combination of series and parallel networks. This network is called corporate because the structure resembles a hierarchy of a corporation. In particular, an N-way (N=4n, n=1, 2, 3, . . . ) corporate quadrature hybrid coupler network consists of N-1 quadrature hybrid couplers. For some cases, an unequal amplitude quadrature hybrid coupler is used to achieve an N-1 rule. The method of operation of the 4-way corporate quadrature hybrid coupler network 200 is similar to the method of operation of a single quadrature hybrid coupler shown in FIG. 1.

In this exemplary prior art 4-way coupler network 200, three quadrature hybrid couplers 202, 204, 206 are connected to each other on a printed circuit board 208. Specifically, for a power combining case with all ports matched to 50 Ω, the RF power enters port P1 210, port P2 212, port P3 214, and port P4 216 at the same amplitude and frequency but with different phases. Relative to port P1 210, port P2 212 leads by 90°, port P3 214 leads by 180°, and port P4 216 leads by 90°. The RF power entering ports P1 210, P2 212, P3 214, and P4 216 is combined at port P5 218. In particular, coupler 202 and coupler 204 are parallel to each other, and a connector port 220 of coupler 202 and a connector port 222 of coupler 204 are connected to the connector ports 224, 226 of coupler 206. In this case, connector ports 220 and 222 are output connector ports of couplers 202 and 204, respectively, and connector ports 224, 226 are input connector ports of coupler 206. For the power divider case with all ports being matched to 50 Ω, the RF power entering port P5 is divided between ports P1 210, P2 212, P3 214, and P4 216. The phase difference relative to P1 is generally as follows: port P2 212 lags by 90°, port P3 214 lags by 180°, and port P4 216 lags by 90°.

With either the combining or the dividing cases, each of the couplers 202, 204, 206 respectively includes an isolation port 228, 230, 232. Three isolation resistors 234, 236, 238 are respectively, in turn, used to terminate each of the isolation ports 228, 230, 232. In theory, the isolation resistors 234, 236, 238 do not dissipate any RF power because they are isolated. In practical application, however, the isolation resistors 234, 236, 238 actually absorb the RF power that is coupled to the isolation ports 228, 230, 232 due to non-ideal performance of the quadrature hybrid coupler.

There are four main conditions where the isolation resistor 234, 236, 238 may absorb the RF power that is coupled to the isolation ports 228, 230, 232. The first condition deals with design limitations. Specifically, since it is impossible to design with infinite isolation between the parallel ports due to physical limitations, such as conductor, dielectric losses, and non-ideal resistive/reactive components, the isolation is degraded. The second condition is that any amplitude or phase imbalance inherent to the design caused by non-ideal circuit optimization, layout compensation for branch-line discontinuity, or the variance in RF input power will ultimately couple the RF power to the isolation ports. The third condition is specific to the power dividing case where any reflected RF power from the output ports caused by non-ideal output port termination will be coupled to the isolation port on the input side, assuming the output ports present identical reflection coefficient that is greater than zero but not greater than the magnitude of one. Moreover, during power combining, the fourth condition is when only one of two RF power enters its respective input port, half of the RF input power would be coupled to the isolation port while the other half will be coupled to the output port.

Although the isolation resistor should have sufficient RF power dissipation capability to handle the RF power coupled to the isolation port during these non-ideal conditions, the cost can be high for high power applications due to the RF power handling criteria of the isolation resistor, which can be costly. Moreover, surface mount of low-Coefficient of Thermal Expansion (“low-CTE”), such as BeO or AIN, termination resistors on an organic substrate with a copper heat spreader presents thermal-mechanical reliability risks due to a mismatch between the two material sets. As a result, a cracked solder joint that will eventually cause an electrical open can be a possible failure. Moreover, in order to compensate this mismatch of the two material sets, a more expensive heat spreader that matches the low-CTE material of the termination resistor is required, instead. Although this will reduce the thermal-mechanical reliability risk, it does not eliminate the risk. In addition, the method costs substantially more because the heat spreader needed for the low-CTE termination resistor costs four times more than a typical copper heat spreader.

To address these shortcomings, one prior method proposed the use of an equal phase 3 dB coupler with no isolation resistor. For an equal phase non-isolated combining of the output powers of two parallel transistors, the output impedance will ultimately affect both transistors equally. This, however, will result in larger output power variance under a mismatched output impedance. In this prior method, although the balance (90° offset) topology is retained, it is less likely that mismatched output impedance will be varied. Another disadvantage is that phase imbalance between the parallel transistors will reduce the output power. In the idea being presented, the output power may not decrease. Also, if one of the two transistors fails, the insertion loss is 6 dB. As a result, the insertion loss ranges from 6 dB to 1.5 dB, which is a highly undesired range for a coupler network.

### BRIEF DESCRIPTION OF THE DRAWINGS

The above needs are at least partially met through provision of the present coupling technique of RF signal power described in the following detailed description, particularly when studied in conjunction with the drawings, wherein:

FIG. 1 illustrates a general quadrature hybrid coupler;

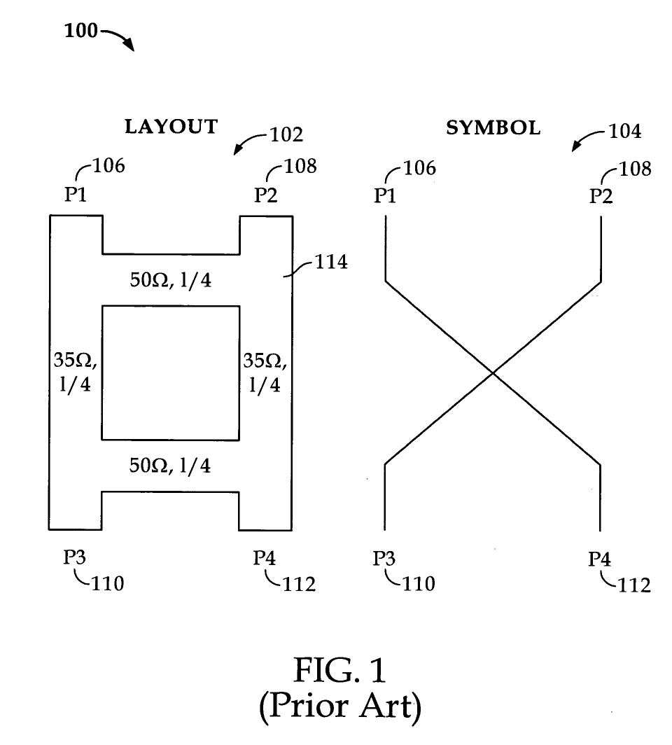

FIG. 2 illustrates a general quadrature hybrid coupler network implemented with three quadrature hybrid couplers;

FIG. 3 illustrates a coupler network implemented with three couplers according to one embodiment of the invention; and

FIG. 4 illustrates a coupler network implemented with seven couplers according to one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, at least one electro magnetic waveguide is operably coupled between an isolation port of two of at least three couplers. In one embodiment, each of the at least three couplers also includes at least three ports that are operably coupled with one another as a corporate coupler network, wherein two of the at least three couplers are substantially parallel to each other. These couplers along with the electro magnetic waveguide are all surface mountable on a printed circuit board. In one of the embodiments, the couplers are quadrature hybrid couplers. In various embodiments, the electro magnetic waveguide can be a coaxial cable, transmission line, attenuator, lumped elements and/or cavity waveguide. Furthermore, according to the various teachings described, the electro magnetic waveguide is preferably configured according to an impedance that is substantially equal to an impedance of the isolation port of the two of the at least three couplers.

Through the teachings of the various embodiments described, an RF power coupling technique is provided that can greatly reduce the cost of the coupler network because at least two of the three termination resistors are eliminated. Aside from reducing the cost of the circuit by eliminating the number of termination resistors needed, mechanical reliability has also been improved since fewer termination resistors must be managed. As the number of combining ports increases, the reduction of the termination resistors also increases, which translates into significant cost reduction for each circuit. Furthermore, since the various teachings allow for the use of a lower cost copper coin, the use of the more expensive low-CTE heat spreader is removed. The reduced number of load resistors also enable improved heat sinking of the surface mount RF power combiners on an organic substrate because the task becomes easier as resistor loads are eliminated or reduced. With this use of a copper coin and heat sinking of surface mount RF power combiners, front end manufacturing variability of the circuit is also reduced since aggressive solder wetting is no longer required for thermal management. As a result of this lower risk, there would be less of a need for module-to-module variation. Also, the use of copper coin and heat sinking of surface mount RF power combiners offers the best overall CTE matching of the copper heat spreader, organic printed circuit board, and organic surface mount RF power combiners.

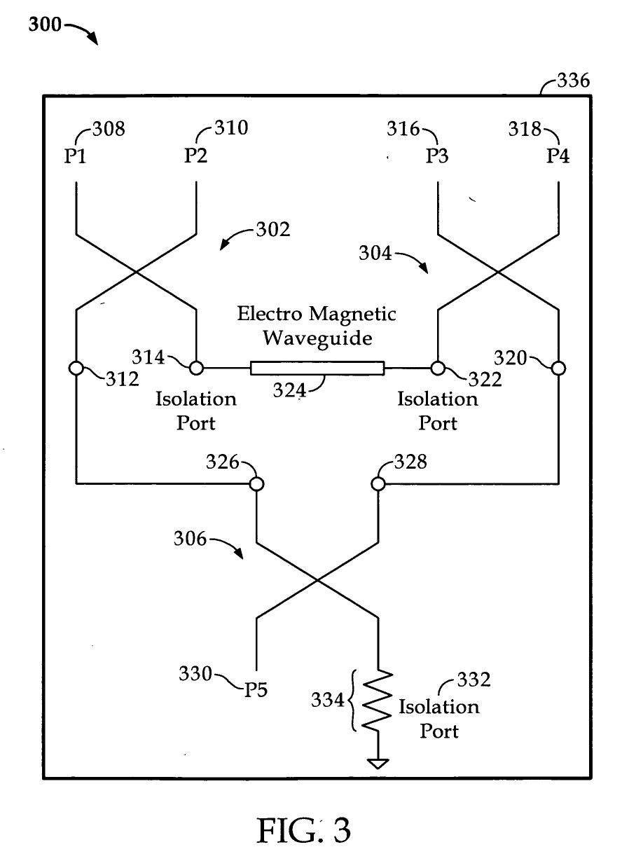

Referring now to the drawings, and in particular to FIG. 3, a coupler network is shown and indicated generally at 300. Those skilled in the art, however, will recognize and appreciate that the specifics of this illustrative example are not specifics of the invention itself and that the teachings set forth herein are applicable in a variety of alternative settings. For example, since the teachings described do not depend upon the type of couplers used, they can be applied to any type of couplers although a quadrature hybrid coupler is shown in this embodiment. As such, other alternative implementations of using different types of couplers and/or coupler networks are contemplated and are within the scope of the various teachings described.

In order to shown a practical example of these various teachings, however, the coupler network 300 is shown with three quadrature hybrid couplers 302, 304, 306 according to this particular embodiment. As discussed in the background, these couplers can be used both as a power divider or combiner, and thus the phase difference of the couplers can be defined specifically for each implementation, which is readily appreciated by one skilled in the art. In this embodiment shown, coupler 302 and coupler 304, being parallel to each other, are connected to coupler 306. Each coupler 302, 304, 306 has four ports. Specifically, coupler 302 includes a port P1 308, a port P2 310, a connector port 312, and an isolation port 314. Similarly, coupler 304 includes a port P3 316, a port P4 318, a connector port 320, and an isolation port 322. Unlike the prior art, however, the isolation port 314 of coupler 302 and the isolation port 322 of coupler 304 are operably coupled to each other with an electro magnetic waveguide 324.

In the various teachings, the electro magnetic waveguide 324 will distribute any RF power due to non-ideal conditions from each of the isolation ports 314, 322. As a result, in this embodiment, two isolation resistors have been eliminated, which would reduce the cost of the circuit, while at the same time the concern of the RF power from the isolation ports 314, 322 has been addressed. In fact, the electro magnetic waveguide 324 is able to handle the RF power from each of the isolation ports 314, 322 better than the isolation resistors, because it will distribute the RF power instead of dissipating it. Multiple types of existing components can be used for the electro magnetic waveguide 324. For example, depending upon the specific implementation, a coaxial cable, a transmission line, an attenuator, lumped elements and/or a cavity waveguide may be used as the electro magnetic waveguide 324. It should be noted, however, that this list is non-exhaustive, and thus other alternatives that are not specifically listed are contemplated, which would be readily appreciated by one skilled in the art. As a result, they are within the scope of the various teachings described. Furthermore, because each of these implementations has its own benefits and disadvantages, any one specific implementation will highly depend upon the purpose, costs, and benefits directed to each specific implementation. For example, the use of the coaxial cable and the transmission line may not be workable if the design requires great control over the amount of isolation needed. The attenuator, on the other hand, will be able to provide the freedom to choose the amount of isolation needed for each application, but it will add cost to the circuit.

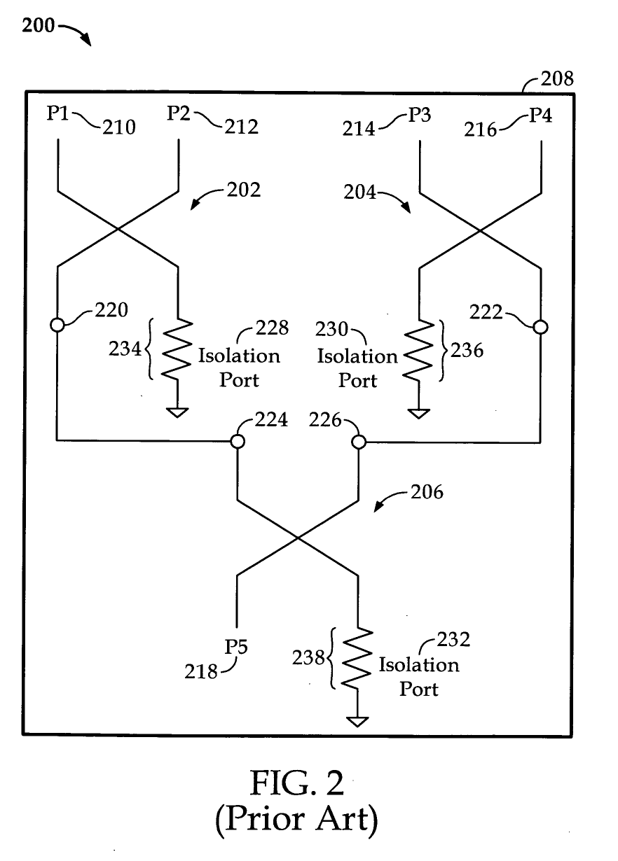

In the various embodiments of the electro magnetic waveguide, an impedance that is substantially equal to an impedance of the isolation ports of the two connected couplers is preferred. Thus, in this embodiment shown, the impedance of the electro magnetic waveguide 324 is substantially equal to the impedance of the isolation ports 314, 322. Furthermore, the electro magnetic waveguide, in one embodiment, is configured substantially according to an integer multiple of a quarter-wave length (i.e., a 90° electrical wavelength) with respect to the operating frequency or the center frequency. With the connected coupler 302 and coupler 304 via the electro magnetic waveguide 324, each of the couplers is then connected to the coupler 306. Specifically, the connector port 312 of the coupler 302 and the connector port 230 of coupler 304 are respectively connected to a connector port 326 and a connector port 328 on the coupler 306. Similar to the other couplers 302, 304, the coupler 306 also includes a port P5 330 and an isolation port 332 where an isolation resistor 334 is coupled. Note that in this embodiment, only one isolation resistor 334 is needed as compared to the prior art of a total of three isolation resistors 234, 236, 238 shown in FIG. 2.

In addition to reducing the production cost by reducing the number of isolation resistors needed, the various teachings also reduce the production costs in other areas as well. Particularly, in this embodiment, all the couplers 302, 304, 306 along with the electro magnetic waveguide are surface mountable on a substrate 336, such as a printed circuit board. Since the various teachings allow for the use of a lower cost copper coin, such as in the implementation of the use of a transmission line, the low-CTE heat spreader, which tends to be more expensive, is removed during production. Moreover, heat sinking of the surface mount RF power combiners on an organic substrate is improved because the task becomes easier as resistor loads are eliminated or reduced. With the use of the copper coin and the heat sinking of surface mount RF power combiners, aggressive solder wetting is also no longer required for thermal management, which reduces front end manufacturing variability. As a result of this lower risk, there would be less of a need for module-to-module variation. Also, the use of copper coin and heat sinking of surface mount RF power combiners offers the best overall CTE matching of the copper heat spreader, organic printed circuit board, and organic surface mount RF power combiners.

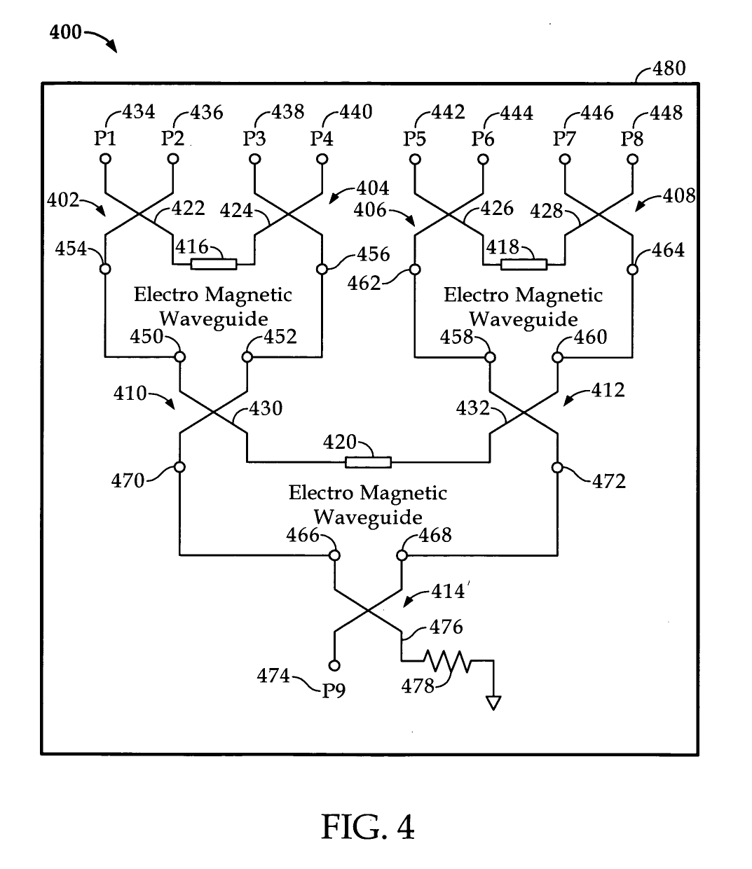

Turning now to FIG. 4, a coupler network implemented with seven couplers according to one embodiment of the invention is shown and indicated generally at 400. This exemplary embodiment is included to show that any N number of coupler(s), where N is greater than one, can be included in the coupler network. In this particular coupler network 400 shown, seven couplers 402, 404, 406, 408, 410, 412, 414 are included. As shown in FIG. 4, there are three sets of couplers that are parallel to each other and operably connected via an electro magnetic waveguide 416, 418, 420. Specifically, an isolation port 422 of coupler 402 and an isolation port 424 of the coupler 404 are connected through a first electro magnetic waveguide 416, and an isolation port 426 of coupler 406 is connected to an isolation port 428 of coupler 408 via a second electro magnetic waveguide 418. Similarly, an isolation port 430 of coupler 410 is connected to an isolation port 432 of coupler 412 via a third electro magnetic waveguide 420.

Furthermore, at the first set of parallel couplers 402, 404, a port P1 434 and a port P2 436 are found on the coupler 402, and a port P3 438 and a port P4 440 are found on the coupler 404. At the second set, ports P5 442 and P6 444 and ports P7 446 and P8 448 are respectively found on coupler 406 and coupler 408. The coupler 410, using connector ports 450, 452, is connected to the first set of couplers 402, 404 via their connector ports 454, 456, respectively. Connector ports 458, 460 of the coupler 412 are respectively connected to a connector port 462 of coupler 406 and a connector port 464 of coupler 408. Finally, connector ports 466, 468 of the coupler 414 are connected to a connector port 470 of the coupler 410 and a connector port 472 of the coupler 412. In this embodiment, the coupler 414 also includes a port P9 474 and an isolation port 476 where a single isolation resistor 478 is found. In this embodiment, the single isolation resistor 478 replaces the seven isolation resistors needed in the prior art coupler network. Again, this, as shown, substantially reduces the cost of the circuit, while at the same time, the mechanical reliability has also been improved since fewer termination resistors must be managed. Similarly, the couplers 402, 404, 406, 408, 410, 412, 414 along with the electro magnetic waveguides 416,418, 420 can again be surface mounted on a substrate, such as a printed circuit board.

With these various teachings shown, a novel RF power coupling technique has been provided. In particular, with the various embodiments described, a coupler network that requires far fewer isolation resistors has been provided, which greatly reduces the total cost of the circuit. For example, in the embodiment with the fewest number of couplers, a single isolation resistor is used as compared to the prior coupler network of using three isolation resistors. The substantial saving in cost becomes even more apparent because a single isolation resistor is needed for any given number N of couplers in the network. Mechanical reliability is also improved since fewer termination resistors need to be managed. Furthermore, because the various teachings allow for the use of a lower cost copper coin, the use of the more expensive low-CTE heat spreader is also eliminated, which also results in substantial savings during production. The reduced number of load resistors also enable improved heat sinking of the surface mount RF power combiners on an organic substrate because the task becomes easier as the resistor loads are eliminated or reduced. This provides for the best overall CTE matching of the copper heat spreader, organic printed circuit board, and organic surface mount RF power combiners, which also reduces front end manufacturing variability of the circuit since aggressive solder wetting is no longer required for thermal management. As a result of this lower risk, there would be less of a need for module-to-module variation.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. An apparatus for coupling radio frequency signal power comprising:
at least three couplers operably coupled with one another as a corporate coupler network, wherein each of the at least three couplers comprises:
at least three ports on the coupler;
an isolation port on the coupler;
at least one electro magnetic waveguide operably coupled between the isolation ports of two of the at least three couplers.

2. The apparatus according to claim 1, wherein the electro magnetic waveguide comprises at least one selected from a group of a coaxial cable, a transmission line, an attenuator, lumped elements and a cavity waveguide.

3. The apparatus according to claim 1, wherein the at least three couplers are selected from a group consisting of quadrature hybrid couplers and 180° couplers.

4. The apparatus according to claim 1, wherein the at least one electro magnetic waveguide is configured substantially according to an integer multiple of a quarter-wave length with respect to at least one selected from a group of an operating frequency and a center frequency.

5. The apparatus according to claim 1, wherein the at least one electro magnetic waveguide is configured according to an impedance that is substantially equal to an impedance of the isolation ports of the two of the at least three couplers.

6. The apparatus according to claim 1, wherein the two of the at least three couplers are substantially parallel to each other.

7. The apparatus according to claim 1 further comprising:
a printed circuit board, wherein the at least three couplers and the at least one electro magnetic waveguide are surface mounted onto the printed circuit board.

8. An apparatus for transmitting radio frequency signal power comprising:
a printed circuit board;
at least three couplers operably coupled with one another as a corporate coupler network mounted on the printed circuit board, wherein each of the at least three couplers comprises:
at least three ports on the coupler;
an isolation port on the coupler;
at least one electro magnetic waveguide operably coupled between the isolation port of two of the at least three couplers.

9. The apparatus according to claim 8, wherein the electro magnetic waveguide comprises at least one selected from a group of a coaxial cable, a transmission line, an attenuator, lumped elements and a cavity waveguide.

10. The apparatus according to claim 8, wherein the at least three couplers are selected from a group consisting of quadrature hybrid couplers and 180° couplers.

11. The apparatus according to claim 8, wherein the at least one electro magnetic waveguide is configured according to an impedance that is substantially equal to an impedance of the isolation ports of the two of the at least three couplers.

12. The apparatus according to claim 8, wherein the two of the at least three couplers are substantially parallel to each other.

13. The apparatus according to claim 8, wherein the at least one electro magnetic waveguide is configured substantially to an integer multiple of a quarter-wave length with respect to at least one selected from a group of an operating frequency and a center frequency.

14. The apparatus according to claim 10, wherein the at least three couplers are surface mounted onto the printed circuit board.

15. An apparatus for coupling radio frequency signal power comprising:
at least three couplers operably coupled with one another as a corporate coupler network, wherein each of the at least three couplers comprises:
at least two ports on one end of the coupler;
at least one port and an isolation port on another end of the coupler;
at least one electro magnetic waveguide operably coupled between the isolation ports of two of the at least three couplers.

16. The apparatus according to claim 15, wherein the electro magnetic waveguide comprises at least one selected from a group of a coaxial cable, a transmission line, an attenuator, lumped elements and a cavity waveguide.

17. The apparatus according to claim 15, wherein the at least three couplers are selected from a group consisting of quadrature hybrid couplers and 180° couplers.

18. The apparatus according to claim 15, wherein the at least one electro magnetic waveguide is configured substantially according to an integer multiple of a quarter-wave length with respect to at least one selected from a group of an operating frequency and a center frequency.

19. The apparatus according to claim 15, wherein the at least one electro magnetic waveguide is configured according to an impedance that is substantially equal to an impedance of the isolation ports of the two of the at least three couplers.

20. The apparatus according to claim 15, wherein the two of the at least three couplers are substantially parallel to each other.
